(19) United States
(12) Patent Application Publication
(10) Pub. No.: US 2024/0010477 A1
(43) Pub. Date: Jan. 11, 2024

(54) CRAWLER VEHICLE FOR THE PREPARATION OF SKI RUNS AND METHOD TO CONTROL A WINCH OF THE CRAWLER VEHICLE

(71) Applicant: PRINOTH S.P.A., Vipiteno (IT)

(72) Inventors: Martin Kirchmair, Vipiteno (IT); Alberto Paoletti, Vipiteno (IT); Markus Unterholzner, Vipiteno (IT); Gregor Maurer, Vipiteno (IT); Francesco Salis, Vipiteno (IT)

(21) Appl. No.: 18/037,705

(22) PCT Filed: Nov. 24, 2021
(86) PCT No.: PCT/IB2021/060931

§ 371 Date: May 18, 2023

(30) Foreign Application Priority Data
Nov. 24, 2020 (IT) 102020000028169

(51) Int. Cl. B66D 1/38; E01H 4/02

(52) U.S. Cl. CPC B66D 1/38; E01H 4/02

(57) ABSTRACT

A crawler vehicle for the preparation of ski runs; the crawler vehicle comprising: a frame; a winch mounted on the frame for selectively unwinding and winding a cable that can be anchored to a point outside the crawler vehicle; an arm, which is mounted swivelling with respect to the frame around a determined axis, and is configured to guide the cable; an actuating system of the arm around the determined axis; a control device of the actuating system of the arm for selectively setting one of the following operating modes when the cable is under tension: enabling the free rotation of the arm around the determined axis; rotating the arm around the determined axis; locking the position of the arm with respect to the frame.

### PRIORITY CLAIM

This application is a national stage application of PCT/IB2021/060931, filed on Nov. 24, 2021, which claims the benefit of and priority to Italian Patent Application No. 102020000028169, filed on Nov. 24, 2020, the entire contents of which are each incorporated by reference herein.

### TECHNICAL FIELD

The present disclosure relates to a crawler vehicle for the preparation of ski runs.

### BACKGROUND

Generally, a crawler vehicle for the preparation of ski runs comprises a frame; a cabin mounted on the frame; a propulsion system mounted on the frame; driving wheels actuated by the propulsion system; and tools supplied by the propulsion system.

When the crawler vehicle is used for the preparation of particularly steep ski runs, the crawler vehicle is equipped with a winch, which is mounted on the frame and comprises an arm configured to guide and selectively orient the cable of the winch with respect to the frame around a determined axis.

Generally, the arm is rotated around the determined axis so as to control the arm when the free end of the cable of the winch is not anchored to a point outside the crawler vehicle. Generally, when the cable is under tension the arm is left free to orient itself around the axis, thus the arm in this configuration is aligned with the portion of cable outside the arm.

When the direction of the force exerted by the cable on the crawler vehicle does not pass through the barycentre of the crawler vehicle, said force applies a yawing torque to the crawler vehicle. In overcome this drawback, EP Patent Document No. 1,896,661 teaches how to automatically compensate the yawing torque through a torque applied to the arm so as to arrange the arm in a determined position in which the prolongation of the cable outside the crawler vehicle is aligned with the barycentre of the crawler vehicle. Theoretically, in this manner, the yawing torque is eliminated.

The automatic compensation of the yawing torque provides for acquiring the angle of the arm with respect to the frame around the determined axis and the entity of the yawing torque so as to compute and automatically apply the corrective torque so as to compensate at least in part the yawing torque.

The application of the automatic compensation of the yawing torque limits possible beneficial uses thereof.

### SUMMARY

An object of the present disclosure is to provide a crawler vehicle for the preparation of ski runs which reduces certain of the drawbacks of certain of the known art.

In accordance with the present disclosure, a crawler vehicle for the preparation of ski runs is realised; the crawler vehicle comprising a frame; a winch mounted on the frame for selectively unwinding and winding a cable that can be anchored to a point outside the crawler vehicle; an arm, which is mounted swivelling with respect to the frame around a determined axis, and is configured to guide the cable; an actuating system of the arm around the determined axis; and a control device of the actuating system of the arm to select an operating mode between the operating modes of: enabling the free rotation of the arm around the determined axis when the cable is under tension; rotating the arm around the determined axis when the cable is under tension; and locking the position of the arm with respect to the frame when the cable is under tension. In this manner, it is possible to control the yawing torque in any operating step and use it for driving the crawler vehicle, if necessary.

In particular, the actuating system comprises at least one actuator coupled to the arm for selectively transmitting to the arm a torque around the determined axis, so as to selectively actuate one of the operating modes.

More specifically, the at least one actuator is configured to transmit a variable torque between a minimum and a maximum value, so as to adjust the torque transmitted to the arm.

Practically, the at least one actuator is a two-way flow hydraulic motor supplied with a pressure variable between a minimum and a maximum value. In this manner, it is possible to selectively vary the direction of the torque transmitted to the arm.

With the purpose to control the at least one hydraulic motor, the actuating system comprises a hydraulic circuit supplied by a pressure source and comprises a pressure regulating valve, so as to adjust the force transmitted by the at least one actuator.

In particular, the actuating system comprises for each hydraulic motor a direction control valve for selectively excluding the supply to the respective hydraulic motor or supplying the respective hydraulic motor in a first direction of flow or supplying the respective hydraulic motor in a second direction of flow opposite to the first direction of flow. In this manner, it is simultaneously possible to selectively eliminate the torque transmitted by the at least one actuator to the arm and/or to selectively vary the direction of the torque so as to control the steering of the crawler vehicle.

In particular, the control device is configured to manually control the pressure regulating valve and to control the direction control valves. In this manner, an operator of the crawler vehicle can manually control the actuating system and set the desired operating mode.

In particular, the control device comprises a joystick, so as to enable the operator of the crawler vehicle to control the actuating system in a relatively simple and intuitive manner.

In particular, the actuating system comprises two actuators. In this manner, it is possible to transmit to the arm respective torques in opposite direction around the determined axis.

A further object of the present disclosure is to provide a method to control the winch of the crawler vehicle which reduces certain of the drawbacks of certain of the known art.

In accordance with the present disclosure, a method to control the winch of the crawler vehicle as previously described is provided. The method comprises applying a minimum torque to the arm through each actuator and opposite to the minimum torque applied by the other actuator so as to enable the arm to align with the cable. In accordance with such method, it is possible to enable or allow a free rotation of the arm around the determined axis.

In accordance with the present disclosure, a further method to control the winch of the crawler vehicle as previously described is provided. The method comprises applying a torque through the at least one actuator to rotate the arm around said determined axis. In this manner, it is possible to control the steering of the crawler vehicle and possibly apply a torque to the arm of a direction opposite to the yawing torque so as to favour the steering.

In accordance with the present disclosure, a further method to control the winch of the crawler vehicle as previously described is provided. The method comprises applying a maximum torque to the arm through each actuator and opposite to the maximum torque applied by the other actuator. In this manner, it is possible to lock the position of the arm with respect to the frame. In the case where the crawler vehicle moves downhill, such method allows or enables maintaining the crawler vehicle aligned with the forward direction preventing the crawler vehicle from yawing.

### BRIEF DESCRIPTION OF THE DRAWINGS

Further characteristics and advantages of the present disclosure will be apparent from the following description of a non-limiting example embodiment, with reference to the attached figures, wherein:

FIG. 1 is a side elevation view, with parts removed for clarity and with schematic parts, of a crawler vehicle realised according to the present disclosure;

FIGS. 2 and 3 are top views, with parts removed for clarity and with schematic parts, of the crawler vehicle of FIG. 1 in respective operating configurations; and

FIG. 4 is a schematic view of a detail of the crawler vehicle of FIG. 1.

### DETAILED DESCRIPTION

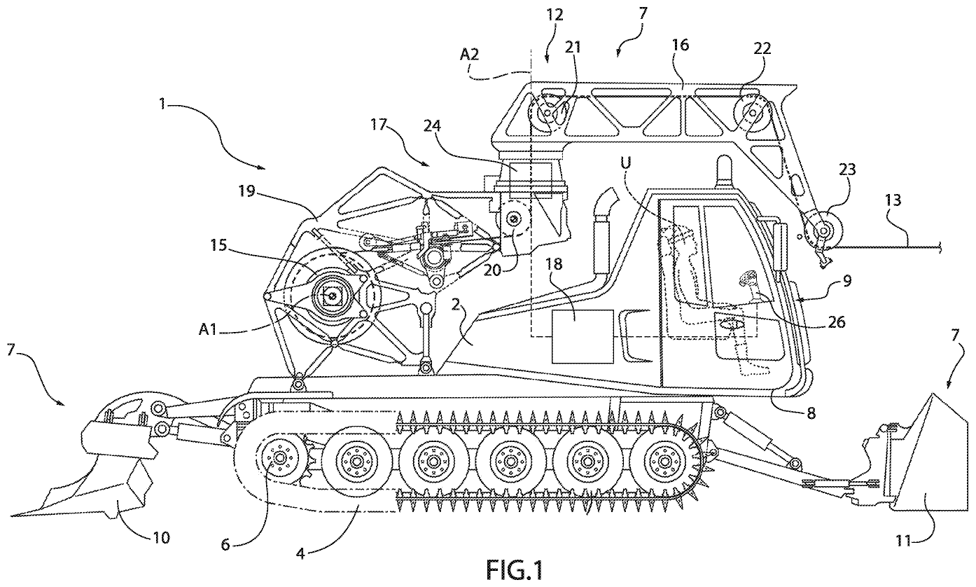

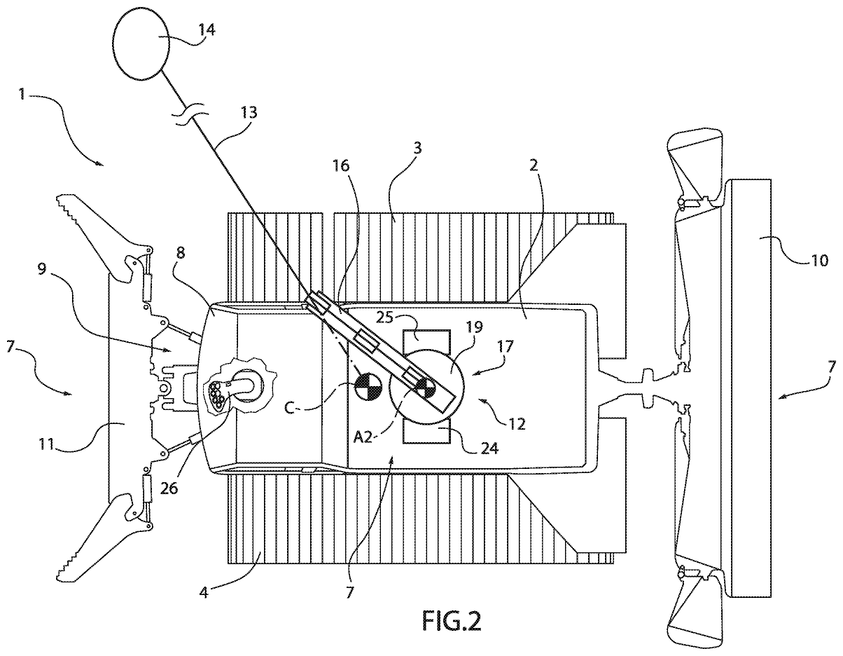

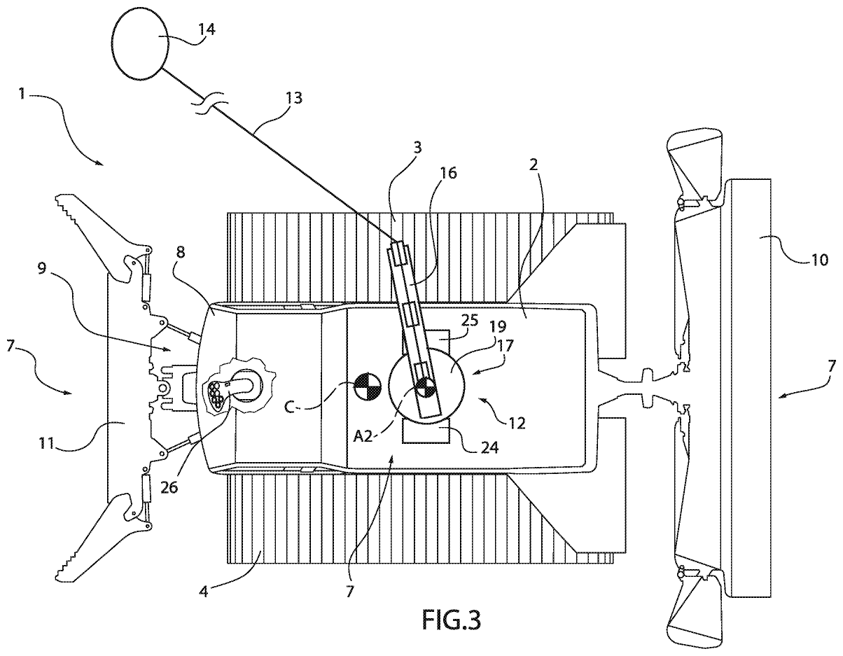

With reference to FIG. 1, reference numeral 1 indicates, as a whole, a crawler vehicle for the preparation of ski runs. The crawler vehicle 1 comprises a frame 2; a track 3 (FIGS. 2 and 3); a track 4; a driving wheel 5 (FIGS. 2 and 3) and a driving wheel 6 independent of one another and coupled to the track 3 (FIGS. 2 and 3) and to the track 4 respectively; a plurality of tools 7 hydraulically actuated and connected to the frame 2; a cabin 8 mounted on the frame 2; and a user interface 9 arranged inside the cabin 8.

In particular, the tools 7 comprise a miller 10 connected in movable manner to the frame 2; a shovel 11 connected in movable manner to the frame 2; and a winch 12 mounted on the frame 2 and configured to selectively unwind and wind a cable 13 that can be anchored to a point 14 (FIGS. 2 and 3) outside the crawler vehicle 1.

In accordance with a non-limiting embodiment of the present disclosure, the cabin 8 is arranged at the front of the crawler vehicle 1 and faces the shovel 11. In such configuration, the winch 12 comprises a drum 15 which swivels around a rotation axis A1 for the winding and unwinding of the cable 13 and is arranged at the back of the crawler vehicle 1, behind the cabin 8.

Furthermore, the crawler vehicle 1 comprises an arm 16, which is mounted swivelling with respect to the frame 2 around a determined axis A2, and is configured to guide the cable 13; an actuating system 17 of the arm 16 around the determined axis A2; and a control device 18 of the actuating system 17 of the arm 16 configured to selectively set one of the following operating modes when the cable 13 is under tension: enabling or allowing the free rotation of the arm 16 around the determined axis A2; rotating the arm 16 around the determined axis A2; and locking the position of the arm 16 with respect to the frame 2.

More specifically, the crawler vehicle 1 comprises a supporting structure 19 fixed to the frame 2, which supports the drum 15 of the winch 12 and supports in a swivelling manner the arm 16; and a series of idle pulleys 20, 21, 22 and 23 which are mounted in a swivelling manner on the supporting structure 19 and on the arm 16 and have the function of guiding the cable 13 along a determined path.

The actuating system 17 comprises two actuators 24 and 25 (FIGS. 2 and 3) coupled to the arm 16 and configured to selectively transmit to the arm 16 respective torques around the determined axis A2.

In accordance with further embodiments, the number of the actuators can vary and is not to be understood as limiting of the present disclosure. By way of example, the actuating system 17 can comprise one single actuator or, alternatively, four actuators.

The control device 18 uses the user interface 9 configured to enable an operator U of the crawler vehicle 1 to control the actuating system 17 and comprises a joystick 26 controllable by the operator U.

With reference to FIGS. 2 and 3, the crawler vehicle 1 has a barycentre C, which is arranged at a distance from the determined axis A2.

In the case described and illustrated herein, the actuators 24 and 25 are supported by the supporting structure 19 and are arranged on opposite sides with respect to the arm 16.

In particular, the actuators 24 and 25 are two-way flow hydraulic motors supplied with a pressure variable between a minimum and a maximum value so as to transmit a variable torque between a minimum and a maximum value.

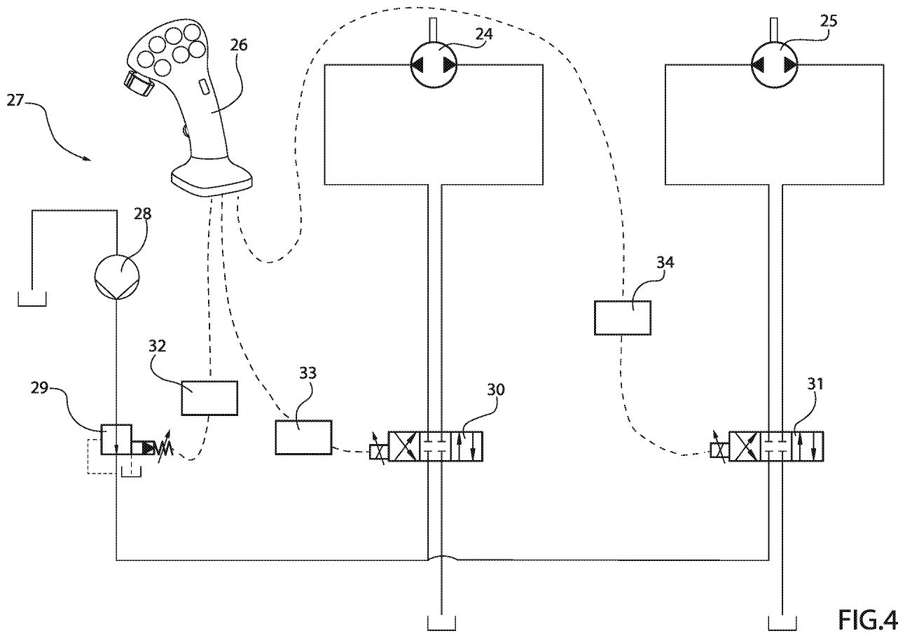

With reference to FIG. 4, the actuating system 17 comprises a hydraulic circuit 27, which is supplied by a pressure source 28 and comprises a pressure regulating valve 29 configured to adjust the supply pressure of each actuator 24 and 25 between a minimum and a maximum value.

Furthermore, the actuating system 17 comprises a direction control valve 30 and a direction control valve 31, each of which is configured to selectively exchide the supply to the respective actuator 24, 25 or to supply the respective actuator 24, 25 in a first direction of flow or to supply the respective actuator 24, 25 in a second direction of flow opposite to the first direction of flow.

In particular, the actuating system comprises control modules 32, 33 and 34, which are configured to control the pressure regulating valve 29, the direction control valve 30 and the direction control valve 31 respectively, depending on the commands given by the joystick 26 and on the operating mode selected.

More specifically, each control module 32, 33, 34 is configured to control the respective valve 29, 30, 31 so that the commands given by the joystick 26 supply the actuators 24 and 25 with a pressure and a direction of flow suitable to the selected operating mode.

In use and with reference to FIG. 2, when the cable 13 is under tension, the operator U of the crawler vehicle 1 through the joystick 26 selects the desired operating mode depending on the particular operational needs and on the driving sensations.

With the purpose to enable or otherwise allow the free rotation of the arm 16 around the determined axis A2, to arrange the arm 16 aligned with the portion of cable 13 outside the arm 16, the operator U of the crawler vehicle 1 controls the joystick 26, actuating the pressure regulating valve 29 (FIG. 4) so as to apply a minimum torque to the arm 16 through each actuator 24, 25 and opposite to the minimum torque applied by the other actuator 24, 25.

In the case where the operator U of the crawler vehicle 1 wants to compensate the yawing torque exerted by the cable 13 under tension on the crawler vehicle 1, the operator U controls the joystick 26 so as to adjust, through the pressure regulating valve 29 (FIG. 4), the intensity of the torque exerted by each actuator 24, 25 on the arm 16 and, through each direction control valve 30, 31 (FIG. 4), the direction of the torque exerted by the respective actuator 24, 25 on the arm 16. In such circumstances, the actuators 24 and 25 apply on the arm 16 a torque concordant in direction with the yawing torque and the arm 16 is rotated around the determined axis A2 so as to substantially align the portion of cable 13 outside the arm 16 with the barycentre C of the crawler vehicle 1. This operation is repeated by the operator until the latter deems it necessary.

With reference to FIG. 3, in the case where the operator U of the crawler vehicle 1 wants to steer the crawler vehicle 1 in a desired steering direction, the operator U controls the joystick 26 so that the actuators 24 and 25 apply on the arm 16 a torque opposite in direction to the direction of the desired steering and with an intensity manually adjusted. In such circumstances, the arm 16 is rotated around the determined axis A2 so as to follow the yaw of the crawler vehicle 1 around the barycentre C.

In the case where the operator U of the crawler vehicle 1 wants to move the crawler vehicle 1 forward in a substantially rectilinear direction, the operator U controls the joystick 26 so as to apply a maximum torque to the arm 16 through each actuator 24, 25 and opposite to the maximum torque applied by the other actuator 24, 25. More specifically, the pressure regulating valve 29 (FIG. 4) is adjusted so as to supply with the maximum pressure the actuators 24 and 25 and the direction control valves 30 and 31 (FIG. 4) are adjusted so that the respective actuators 24 and 25 apply on the arm 16 torques of opposite direction. In such circumstances, the arm 16 is substantially locked with respect to the frame 2 in the forward direction of the crawler vehicle 1. The operating mode described above is particularly indicated in the case where the crawler vehicle 1 moves downhill, allowing maintaining the crawler vehicle 1 aligned with the forward direction and preventing unwanted yaws of the crawler vehicle 1.

It is clear that variants to the present disclosure can be made without thereby departing from the scope of protection of the appended claims. That is, the present disclosure also covers embodiments that are not described in the detailed description above as well as equivalent embodiments that are part of the scope of protection set forth in the claims. Accordingly, various changes and modifications to the presently disclosed embodiments will be apparent to those skilled in the art.

The invention claimed is:

1-13. (canceled)

14. A crawler vehicle comprising:
a frame;
a winch mounted on the frame and configured to selectively unwind and wind a cable anchorable to a point spaced apart from the crawler vehicle;
an arm configured to guide the cable, the arm swivelably mounted with respect to the frame around a determined axis;
an actuating system of the arm; and
a control device of the actuating system of the arm configured to select an operating mode of:
enabling a free rotation of the arm around the determined axis when the cable is under tension,
rotating the arm around the determined axis when the cable is under tension, and
locking a position of the arm with respect to the frame when the cable is under tension.

15. The crawler vehicle of claim 14, wherein the actuating system comprises at least one actuator coupled to the arm and configured to selectively transmit to the arm a torque around the determined axis.

16. The crawler vehicle of claim 15, wherein the at least one actuator is configured to transmit a variable torque between a minimum value and a maximum value.

17. The crawler vehicle of claim 15, wherein the actuating system comprises two actuators.

18. The crawler vehicle of claim 15, wherein the at least one actuator comprises a two-way flow hydraulic motor supplied with a pressure variable between a minimum value and a maximum value.

19. The crawler vehicle of claim 18, wherein the actuating system comprises a hydraulic circuit supplied by a pressure source and comprising a pressure regulating valve.

20. The crawler vehicle of claim 19, wherein the control device is configured to manually control the pressure regulating valve.

21. The crawler vehicle of claim 18, wherein the actuating system comprises, for the two-way flow hydraulic motor, a direction control valve configured to one of: selectively exclude the supply to the two-way flow hydraulic motor, selectively supply the two-way flow hydraulic motor in a first direction of flow, and selectively supply the two-way flow hydraulic motor in a second direction of flow opposite to the first direction of flow.

22. The crawler vehicle of claim 21, wherein the control device is configured to control the direction control valve.

23. The crawler vehicle of claim 14, wherein the control device comprises a joystick.

24. A method to control a winch of a crawler vehicle comprising a frame, the winch mounted on the frame and configured to selectively unwind and wind a cable anchorable to a point spaced apart from the crawler vehicle, an arm configured to guide the cable, the arm swivelably mounted with respect to the frame around a determined axis, an actuating system of the arm comprising two actuators coupled to the arm, and a control device of the actuating system of the arm configured to select an operating mode of: enabling a free rotation of the arm around the determined axis when the cable is under tension, rotating the arm around the determined axis when the cable is under tension, and locking a position of the arm with respect to the frame when the cable is under tension, the method comprising applying a minimum torque to the arm through each actuator and opposite to the minimum torque applied by the other actuator to enable the arm to align with the cable.

25. A method to control a winch of a crawler vehicle comprising a frame, the winch mounted on the frame and configured to selectively unwind and wind a cable anchorable to a point spaced apart from the crawler vehicle, an arm configured to guide the cable, the arm swivelably mounted with respect to the frame around a determined axis, an actuating system of the arm comprising at least one actuator coupled to the arm and a control device of the actuating system of the arm configured to select an operating mode of: enabling a free rotation of the arm around the determined axis when the cable is under tension, rotating the arm around the determined axis when the cable is under tension, and locking a position of the arm with respect to the frame when the cable is under tension, the method comprising applying a torque through the at least one actuator to rotate the arm around the determined axis.

26. A method to control a winch of a crawler vehicle comprising a frame, the winch mounted on the frame and configured to selectively unwind and wind a cable anchorable to a point spaced apart from the crawler vehicle, an arm configured to guide the cable, the arm swivelably mounted with respect to the frame around a determined axis, an actuating system of the arm comprising two actuators coupled to the arm, and a control device of the actuating system of the arm configured to select an operating mode of: enabling a free rotation of the arm around the determined axis when the cable is under tension, rotating the arm around the determined axis when the cable is under tension, and locking a position of the arm with respect to the frame when the cable is under tension, the method comprising applying a maximum torque to the arm through each actuator and opposite to the maximum torque applied by the other actuator.
